(19) United States
(12) Patent Application Publication
(10) Pub. No.: US 2026/0109136 A1
(43) Pub. Date: Apr. 23, 2026

(54) LAMINATED METAL SHEET, METHOD OF PRODUCING LAMINATED METAL SHEET, AND LAMINATED METALLIC CONTAINER

(71) Applicant: JFE STEEL CORPORATION, Tokyo (JP)

(72) Inventors: Tatsuki INAMORI, Tokyo (JP); Tomonari HIRAGUCHI, Tokyo (JP); Yoichiro YAMANAKA, Tokyo (JP)

(73) Assignee: JFE STEEL CORPORATION, Tokyo (JP)

(21) Appl. No.: 19/361,267

(22) Filed: Oct. 17, 2025

(30) Foreign Application Priority Data
Oct. 22, 2024 (JP) 2024-186193
Jun. 24, 2025 (JP) 2025-106659

(51) Int. Cl. B32B 15/09; B32B 15/18; B32B 15/20; B32B 37/06; B32B 37/10; B65D 6/00; B65D 8/00

(52) U.S. Cl. CPC B32B 15/09; B32B 37/06; B32B 37/10; B65D 7/04; B65D 7/42; B32B 15/18; B32B 15/20; B32B 2250/02; B32B 2311/24; B32B 2311/30; B32B 2439/66; B32B 2439/70

(57) ABSTRACT

Provided is an inexpensive, low-environmental-burden laminated metal sheet and laminated metallic container that have basic properties such as formability, adhesion between the film and the metal sheet, and corrosion resistance, and that do not suffer from degradation in appearance due to whitening even when subjected to retort sterilization treatment. The laminated metal sheet 10 has a first film 31 laminated on at least one of a front surface 21 or a back surface 22 of a metal sheet 20. The first film 31 is homopolyethylene terephthalate or copolymer polyethylene terephthalate, and w(x) obtained by a linearly polarized laser Raman spectroscopic analysis for a cross section of the first film 31 satisfies the following expressions (1) and (2):

$${{w}_{1730}}^{ID} ( 1. ) \leq 20 {cm}^{- 1} \qquad ( 1 )$$

$${{w}_{1730}}^{ND} ( 1. ) \leq 20 {cm}^{- 1} . \qquad ( 2 )$$

### TECHNICAL FIELD

The present disclosure relates to a laminated metal sheet, a method of producing a laminated metal sheet, and a laminated metallic container.

### BACKGROUND

Metallic containers such as food cans, beverage cans, and 18 L cans are made using metal sheets such as tin-free steel (TFS) and aluminum as materials. Such metal sheets are coated and baked to provide corrosion resistance, durability, weather resistance, and the like. The baking of metal sheets is complicated and requires a significant amount of processing time. Further, when coating a metal sheet, a large amount of solvent is discharged. In view of this, as an alternative to coated metal sheets, laminated metal sheets in which a thermoplastic resin film is laminated onto a metal sheet have been proposed.

The thermoplastic resin film to be used for the laminated metal sheet is required to have basic properties such as formability, adhesion to the metal sheet, and corrosion resistance.

Canned foods are often subjected to a retort sterilization treatment in which the foods are heated by high-temperature steam for sterilization. When a thermoplastic resin film is subjected to a retort sterilization treatment, minute air bubbles may be formed inside the film. The air bubbles have a property of scattering light, and therefore the thermoplastic resin film that contains air bubbles due to retort sterilization treatment appears cloudy and white, which causes a problem of marring the appearance of the canned food. This problem is called retort whitening.

Attempts to suppress retort whitening have been made as follows. For example, Patent Literature (PTL) 1 describes a film made of a polyester composition containing a polyester having ethylene terephthalate as a main repeating unit and a polyester having butylene terephthalate as a main repeating unit, the polyester composition having a crystallization temperature of 65° C. to 120° C., a secondary transition point of 40° C. or higher, and a melting point of 260° C. or higher.

PTL 2 describes a resin-coated metal sheet including polyester resin layers mainly composed of polyethylene terephthalate on both sides, for which the full width at half maximum of a C═O stretching vibration peak determined by laser Raman spectroscopy of a cross section in the thickness direction of the polyester resin layer is 16.0 cm⁻¹ or more and 24.0 cm⁻¹ or less.

PTL 3 describes a polyester resin-coated metal sheet including a non-stretched polyester resin layer on at least one surface of a metal material, the polyester resin layer having a first region on the interface side with the metal material, for which a specific peak determined by laser Raman spectroscopy has a full width at half maximum in a specific range, and a second region on the surface side opposite the metal material, in which the specific peak has a full width at half maximum in a specific range. Further, as a method of producing a polyester resin-coated metal sheet having the above-mentioned properties, a method of producing a polyester resin-coated metal sheet is described, in which a non-stretched polyester resin film is heat-pressurized to a metal material, the polyester resin film is rapidly cooled after the heat-pressurization to form a polyester resin layer on the metal material, and a post-heat treatment is carried out after the rapid cooling.

PTL 4 describes a resin-coated metal sheet including a polyester resin coating layer in which 90 mol % or more of the constituent units are ethylene terephthalate units, for which a full width at half maximum of a C═O stretching vibration peak in a thickness direction cross section of the polyester resin coating layer, as determined by laser Raman spectroscopy, is 18.5 cm⁻¹ or more and 22.0 cm⁻¹ or less at a position 1.0 μm in the thickness direction from the metal sheet side of the polyester resin coating layer, and is 17.0 cm⁻¹ or more and 18.5 cm⁻¹ or less at a position 1.0 μm in the thickness direction from the surface side.

### CITATION LIST

### Patent Literature

PTL 1: JP H05-331302 A
PTL 2: JP 2010-105263 A
PTL 3: JP 2017-213884 A
PTL 4: WO 2021/020549 A1

### SUMMARY

### Technical Problem

As described above, in addition to basic properties such as formability, adhesion between the thermoplastic resin film and the metal sheet, and corrosion resistance, laminated metal sheets are sometimes required to have retort whitening resistance. Further, as a thermoplastic film that achieves retort whitening resistance, a film mainly composed of polyethylene terephthalate and polybutylene terephthalate has been proposed. It is thought that this film is able to suppress retort whitening by forming a large number of microcrystals in the resin film during retort sterilization treatment. Also proposed is a method in which a polyester resin layer on a laminated metal sheet is subjected to a heat treatment to control the crystal structure in the thickness direction of the resin layer.

However, the method described in PTL 1 has the problem of the result being inferior in corrosion resistance to conventional polyester resins and also containing expensive polybutylene terephthalate. Further, according to the methods described in PTL 2 to 4, although retort whitening can be suppressed, a heat treatment needs to be carried out after lamination, which poses a higher environmental burden than conventional methods of producing laminated metal sheets.

The present disclosure is made in view of the above problems. It would be helpful to provide an inexpensive, low-environmental-burden laminated metal sheet and laminated metallic container that have basic properties such as formability, adhesion between the film and the metal sheet, and corrosion resistance, and that do not suffer from degradation in appearance due to whitening even when subjected to retort sterilization treatment.

### Solution to Problem

The inventors have conducted intensive studies to solve the above problems. As a result, it was found that for laminated metal sheets for which a full width at half maximum of a specific peak in a linearly polarized laser Raman spectroscopy spectrum indicates a specific distribution in a cross section (thickness direction cross section) of the film on the laminated metal sheet, such laminated metal sheets do not suffer from degradation in appearance due to whitening even when subjected to retort sterilization treatment. Further, it was found that in order to produce a laminated metal sheet exhibiting the above-mentioned full width at half maximum distribution, it is preferable that a specific relationship is satisfied between an elapsed time from a thermocompression bonding process to a rapid cooling process during lamination and a surface temperature of the thermocompression bonded body immediately before being rapidly cooled in the rapid cooling process.

The present disclosure is based on these findings and further investigation. Primary features of the present disclosure are as follows.

1. A laminated metal sheet comprising a first film laminated on at least one of a front surface and a back surface of a metal sheet, wherein
the first film is homopolyethylene terephthalate or copolymer polyethylene terephthalate, wherein
w(x) obtained by a linearly polarized laser Raman spectroscopic analysis for a cross sectional area of the first film satisfies the following expressions (1) and (2):

$${{w}_{1730}}^{ID} ( 1. ) \leq 20 {cm}^{- 1} \qquad ( 1 )$$

$${{w}_{1730}}^{ND} ( 1. ) \leq 20 {cm}^{- 1} \qquad ( 2 )$$

where w₁₇₃₀^{ID}(x) is the full width at half maximum of a peak due to C═O stretching vibration in the vicinity of 1730 cm⁻¹ when linearly polarized laser light is incident on the cross section of the first film at a position x μm away from the metal sheet side in the thickness direction of the film, with the polarization plane of the light being parallel to the in-plane direction of the film, and
w₁₇₃₀^{ND}(x) is the full width at half maximum of a peak due to C═O stretching vibration in the vicinity of 1730 cm⁻¹ when linearly polarized laser light is incident on the cross section of the first film at a position x μm away from the metal sheet side in the thickness direction, with the polarization plane of the light being parallel to the thickness direction of the film.

2. The laminated metal sheet according to 1, above, wherein
w(x) obtained by the linearly polarized laser Raman spectroscopic analysis for a cross section of the first film satisfies the following expressions (3) and (4):

$$14 {cm}^{- 1} \leq {{w}_{1730}}^{ID} ( 3. ) \leq 20 {cm}^{- 1} \qquad ( 3 )$$

$$14 {cm}^{- 1} \leq {{w}_{1730}}^{ND} ( 3. ) \leq 20 {cm}^{- 1} . \qquad ( 4 )$$

3. The laminated metal sheet according to 1 or 2, above, wherein
w(x) obtained by the linearly polarized laser Raman spectroscopic analysis for a cross section of the first film satisfies the following expressions (5) and (6):

$${{w}_{1730}}^{ID} ( 5. ) \leq 16 {cm}^{- 1} \qquad ( 5 )$$

$$20 {cm}^{- 1} \leq {{w}_{1730}}^{ND} ( 5. ) . \qquad ( 6 )$$

4. A method of producing a laminated metal sheet, the method comprising:
a thermocompression bonding process of thermocompressing a metal sheet that has been preheated and a first film using a laminate roller to produce a thermocompression bonded body; and
a rapid cooling process of rapidly cooling the thermocompression bonded body, wherein
the first film is homopolyethylene terephthalate or copolymer polyethylene terephthalate, and
an elapsed time tq from an end point of the thermocompression bonding process to a start point of the rapid cooling process and a surface temperature Tq of a first film side of the thermocompression bonded body 0.2 s after the end point of the thermocompression bonding process satisfy the following expression (7):

$$0.38 \times Tq - t q - 72 \leq 0. . \qquad ( 7 )$$

5. The method of producing a laminated metal sheet according to 4, above, wherein
a preheating temperature of the metal sheet in the thermocompression bonding process is 250° C. or higher.

6. A laminated metallic container comprising the laminated metal sheet according to any one of 1 to 3, above, as a material.

### Advantageous Effect

According to the present disclosure, it is possible to provide an inexpensive laminated metal sheet and laminated metallic container that have basic properties such as formability, adhesion between the film and the metal sheet, and corrosion resistance, and that do not suffer from degradation in appearance due to whitening even when subjected to retort sterilization treatment.

### BRIEF DESCRIPTION OF THE DRAWINGS

In the accompanying drawings:

FIG. 1A is a diagram illustrating configuration of an example of a laminated metallic container according to the present disclosure, and FIG. 1B is an enlarged cross section diagram of a lid portion of the laminated metallic container illustrated in FIG. 1A.

### DETAILED DESCRIPTION

The present disclosure is described in more detail below with reference to the drawings, but is not necessarily limited to the following description.

### (Laminated Metallic Container)

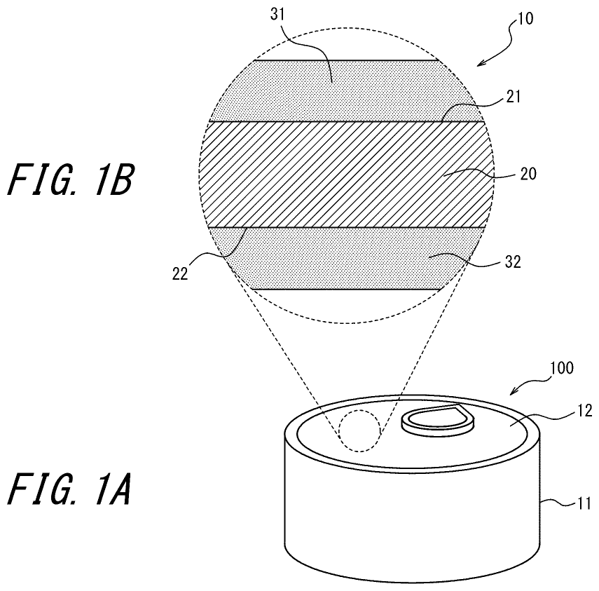

FIG. 1A illustrates the structure of an example of a laminated metallic container according to the present disclosure. As illustrated in FIG. 1A, the laminated metallic container 100 includes a container body 11 formed in a cylindrical shape with a bottom, and further includes a lid portion 12 for closing the container body 11 as required. The laminated metallic container 100 is used, for example, as a food can, a beverage can, an 18 L can, or the like. FIG. 1B illustrates an enlarged cross section diagram of the lid portion 12 of the laminated metallic container 100.

The laminated metallic container 100 may be a three-piece can made by joining three members: a lid material constituting the lid portion 12, and a body material and a base material constituting the container body 11. Further, the laminated metallic container 100 may be a two-piece can formed by joining two members: a lid material constituting the lid portion 12 and a body material with a bottom constituting the container body 11. The laminated metallic container 100 may have an opening in the container body 11, for example, by omitting the lid portion 12.

### (Laminated Metal Sheet)

As illustrated in FIG. 1B, the laminated metallic container 100 includes a laminated metal sheet 10 as a material. In the laminated metallic container 100, one or more of the lid material, body material, and base material described above need not include the laminated metal sheet 10. For example, the body material may be made of a non-laminated metal sheet, and the lid material may be made of the laminated metal sheet 10.

The laminated metal sheet 10 has a front surface 21 that is the outer surface of the laminated metallic container 100 and a back surface 22 that is the inner surface of the laminated metallic container 100. The laminated metal sheet 10 has a first film 31 bonded to at least one of the front surface 21 or the back surface 22 of the metal sheet 20. Further, the laminated metal sheet 10 may be provided with the first film 31 on one of the front surface 21 or the back surface 22 of the metal sheet 20 and a second film 32 on the other surface. In FIG. 1B, the first film 31 is provided so as to cover the front surface 21 of the metal sheet 20. Further, the second film 32 is provided so as to cover the back surface 22 of the metal sheet 20.

The metal sheet 20 is not particularly limited, and may be an aluminum sheet or a steel sheet, which are widely used as materials for metallic containers, and may have been subjected to various surface treatments. In particular, it is preferable to use, as the metal sheet 20, a surface-treated steel sheet (TFS: tin free steel) on which a coating made of metallic chromium and hydrated chromium oxide is formed.

The steel sheet that serves as the steel substrate of the TFS is not particularly limited, but is preferably obtained by recrystallization annealing of low carbon steel or interstitial free (IF) steel and rolling such as temper rolling. The steel sheet that serves as the steel substrate of the TFS may be one that has been subjected to overaging treatment as required. Further, the steel sheet that serves as the steel substrate of the TFS may have been subjected to secondary cold rolling.

As the low carbon steel, for example, steel having a carbon content of 0.010 mass % or more and 0.10 mass % or less may be used. As the IF steel, for example, an ultra low carbon steel having a carbon content of 0.003 mass % or less to which niobium (Nb), titanium (Ti), or the like has been added may be used. Examples of recrystallization annealing include continuous annealing, tight coil annealing, and open annealing.

The mechanical properties of the steel sheet that serves as the steel substrate of the TFS are not particularly limited as long as the steel sheet can be formed into a shape corresponding to the laminated metallic container 100. For example, the yield point of the steel sheet is preferably 220 MPa or more. The yield point of the steel sheet is preferably 580 MPa or less. The Lankford value is preferably 0.8 or more. The absolute value of the in-plane anisotropy of the Lankford value is preferably 0.7 or less. Coating weights of the metal chromium layer and the hydrated chromium oxide layer of TFS are not particularly limited. As chromium equivalent, the coating weight of the metal chromium layer is preferably in a range from 50 mg/m² to 200 mg/m². As chromium equivalent, the coating weight of the hydrated chromium oxide layer is preferably in a range from 3 mg/m² to 30 mg/m². When the coating weights of the metallic chromium layer and the hydrated chromium oxide layer are in the above-mentioned ranges, the coating and the TFS are easily and sufficiently adhered to each other, and the corrosion resistance is improved.

The thickness of the metal sheet 20 is not particularly limited. The thickness of the metal sheet 20 is preferably 0.10 mm or more. Further, the thickness of the metal sheet 20 is preferably 0.35 mm or less. When the thickness of the metal sheet 20 is 0.10 mm or more, the rigidity of the laminated metallic container 100 when formed is improved. Further, when the thickness of the metal sheet 20 is 0.35 mm or less, the weight of the laminated metallic container 100 can be decreased, and the energy consumed when forming the laminated metallic container 100 and the energy consumed during transportation can be decreased.

### (First Film)

As the resin constituting the first film 31, copolymerized polyethylene terephthalate can be suitably used, and homopolyethylene terephthalate can be more suitably used. When the first film 31 is made of homopolyethylene terephthalate, the crystallization rate of the first film 31 is high, and the retort whitening resistance can be more effectively exhibited.

Examples of a copolymerization component of the copolymerized polyethylene terephthalate include, as acid components, aromatic dicarboxylic acids such as isophthalic acid, phthalic acid, naphthalenedicarboxylic acid, diphenyldicarboxylic acid, diphenyletherdicarboxylic acid, diphenylsulfonedicarboxylic acid, diphenoxyethanedicarboxylic acid, and 5-sodiumsulfoisophthalic acid, and aliphatic dicarboxylic acids such as oxalic acid, succinic acid, adipic acid, suberic acid, sebacic acid, dimer acid, maleic acid, fumaric acid, dodecanedioic acid, and cyclohexanedicarboxylic acid, and ester derivatives thereof.

Examples of a copolymerization component of the copolymerized polyethylene terephthalate include, as alcohol components, propanediol, butanediol, pentanediol, hexanediol, neopentyl glycol, cyclohexanedimethanol, diethylene glycol, triethylene glycol, polyalkylene glycol, 2,2-bis(4-hydroxyethoxyphenyl) propane, isosorbide (1,4:3,6-dianhydroglucitol, 1,4:3,6-dianhydro-D-sorbitol), spiroglycol, bisphenol A, bisphenol S, and the like.

The copolymerization component of the copolymerized polyethylene terephthalate may be one of the above-mentioned components or a combination of two or more. Isophthalic acid (IA) is preferably used as a copolymerization component of the copolymerized polyethylene terephthalate. When isophthalic acid is used as a copolymerization component of the first polyester, the content is preferably 1 mol % or more. The content is preferably 15 mol % or less. The content is more preferably 2 mol % or more. The content is more preferably 13 mol % or less. The content is even more preferably 3 mol % or more. The content is even more preferably 7 mol % or less. When isophthalic acid is used as a copolymerization component and the content is 1 mol % or more, the first film 31 and the metal sheet 20 tend to adhere to each other sufficiently. Further, when isophthalic acid is used as a copolymerization component and the content is 15 mol % or less, a cooling crystallization temperature of the first film 31 is high, and the retort whitening resistance can be exhibited even when the elapsed time from the thermocompression bonding process to the rapid cooling process during lamination is short.

Intrinsic viscosity of the first film 31 is preferably 0.65 dL/g or more. Intrinsic viscosity is preferably 1.00 dL/g or less. Intrinsic viscosity is more preferably 0.70 dL/g or more. Intrinsic viscosity is more preferably 0.90 dL/g or less. When the intrinsic viscosity of the first film 31 is 0.65 dL/g or more, the formability of the laminated metal sheet 10 is improved. When the intrinsic viscosity of the first film 31 is 1.00 dL/g or less, energy consumption in the polymerization process and the extrusion process can be suppressed.

Cooling crystallization peak temperature (Tcc) of the first film 31 is preferably 185° C. or higher. The cooling crystallization peak temperature is preferably 205° C. or lower. The cooling crystallization peak temperature is more preferably 190° C. or higher. The cooling crystallization peak temperature is more preferably 200° C. or lower. The cooling crystallization peak temperature is the peak temperature of an exothermic peak when the temperature of the film is lowered from 290° C. at a rate of 10° C./min according to differential scanning calorimetry (DSC). When the cooling crystallization peak temperature of the first film 31 is 185° C. or higher, crystallization proceeds even at a high temperature, making it easier to obtain good retort whitening resistance. Further, when the cooling crystallization peak temperature of the first film 31 is 205° C. or lower, degradation of formability due to excessive crystallization can be suppressed.

The first film 31 may contain additives such as antioxidants, inorganic lubricants, organic lubricants, crystal nucleating agents, heat stabilizers, antistatic agents, and coloring pigments in addition to homopolyethylene terephthalate or copolymer polyethylene terephthalate.

In particular, the first film 31 preferably contains an antioxidant in a range from 0.0001 mass % to 1.0000 mass %. When the antioxidant is contained in the range from 0.0001 mass % to 1.0000 mass %, heat resistance of first film 31 is improved. The antioxidant is not particularly limited, and known antioxidants classified into hindered phenols, hydrazines, phosphites, and the like may be used.

Further, the first film 31 preferably contains an inorganic lubricant in a range from 0.01 mass % to 0.50 mass %. When the first film 31 contains the inorganic lubricant in the range from 0.01 mass % to 0.50 mass %, the ease of handling of the first film is improved. The inorganic lubricant is not particularly limited, and known inorganic lubricants such as silicon oxide, diatomaceous earth, and talc may be used.

The first film 31 may be configured as a plurality of layers laminated in the thickness direction. Methods of laminating multiple layers include known methods such as coextrusion using a feed block or a multi-manifold, laminating multiple films together, and laminating molten resin directly onto a film. The method of laminating the first film 31 is preferably a co-extrusion method in order to increase productivity and decrease energy consumption.

As described above, when the first film 31 is configured as a plurality of layers, it is preferable that the outermost layer contains an inorganic lubricant in a range from 0.01 mass % to 0.50 mass %. Further, it is preferable that layers other than the outermost layer do not contain an inorganic lubricant or contain an inorganic lubricant in a range of 0.01 mass % or less. For example, when the first film 31 is composed of three layers, namely, an air-side surface layer, a core layer, and a metal sheet-side layer, an example is a configuration in which the air-side surface layer and the metal sheet-side layer contain an inorganic lubricant, and the core layer does not contain an inorganic lubricant. By containing an inorganic lubricant only in the outermost layer, the amount of inorganic lubricant used can be suppressed, which is economical.

The first film 31 preferably contains an organic lubricant in a range from 0.01 mass % to 1.00 mass %. When the first film 31 contains an organic lubricant in the range from 0.01 mass % to 1.00 mass %, the formability of the laminated metal sheet 10 is improved. When the first film 31 is configured as a plurality of layers, it is preferable that the outermost layer contains an organic lubricant in a range from 0.01 mass % to 1.00 mass %. The organic lubricant is not particularly limited, but any known organic lubricant such as carnauba wax, polyolefin wax, or modified polyolefin wax may be used.

The average thickness of the first film 31 is preferably 7 μm or more. The average thickness is preferably 50 μm or less. The average thickness of the first film 31 is more preferably 8 μm or more. The average thickness is more preferably 30 μm or less. The average thickness is even more preferably 10 μm or more. The average thickness is even more preferably 22 μm or less. When the average thickness of the first film 31 is 7 μm or more, better corrosion resistance can be secured when the laminated metal sheet 10 is formed into the laminated metallic container 100. When the average thickness of the first film 31 is 50 μm or less, the energy consumption required for heating during the production of the first film 31 and the laminated metal sheet 10 can be suppressed.

A sample standard deviation of the thickness of the first film 31 is preferably 10% or less of an average thickness of the first film 31. The sample standard deviation is more preferably 5% or less. When the sample standard deviation of the thickness of the first film 31 is 10% or less of the average thickness of the first film 31, breakage of the first film 31 or the metal sheet 20 can be suppressed when the laminated metal sheet 10 is formed into the laminated metallic container 100.

The average thickness and the sample standard deviation of the first film 31 are values calculated by calculating the sample standard deviation and the average thickness for 1000 points measured at 1 mm intervals over 1000 mm in the longitudinal direction of the first film 31 using a constant pressure thickness meter.

w(x) obtained by a linearly polarized laser Raman spectroscopic analysis for a cross section of the first film 31 satisfies the following expressions (1) and (2):

$${{w}_{1730}}^{ID} ( 1. ) \leq 20 {cm}^{- 1} \qquad ( 1 )$$

$${{w}_{1730}}^{ND} ( 1. ) \leq 20 {cm}^{- 1} \qquad ( 2 )$$

Here, w₁₇₃₀^{ID}(x) is the full width at half maximum of a peak due to C═O stretching vibration in the vicinity of 1730 cm⁻¹ when linearly polarized laser light is incident on the cross section of the first film 31 at a position x μm away from the metal sheet 20 side in the thickness direction of the film, with the polarization plane of the light being parallel to the in-plane direction of the film. Further, w₁₇₃₀^{ND}(x) is the full width at half maximum of a peak due to C═O stretching vibration in the vicinity of 1730 cm⁻¹ when linearly polarized laser light is incident on the cross section of the first film 31 at a position x μm away from the metal sheet 20 side in the thickness direction, with the polarization plane of the light being parallel to the thickness direction of the film.

The Raman peak at a wavenumber in the vicinity of 1730 cm⁻¹ is due to the C═O stretching vibration in the ester group of polyethylene terephthalate, and the full width at half maximum of the peak becomes narrower as the crystallinity of the polyethylene terephthalate increases. Further, by using linearly polarized laser light as a light source for Raman spectroscopy, it is possible to obtain only information on C═O bonds oriented in the same direction as the polarization direction.

Further, w₁₇₃₀^{ID}(1.0) is 20 cm⁻¹ or less. w₁₇₃₀^{ID}(1.0) is preferably 19 cm⁻¹ or less. Further, w₁₇₃₀^{ID}(1.0) is preferably 13 cm⁻¹ or more. w₁₇₃₀^{ID}(1.0) is more preferably 15 cm⁻¹ or more. w₁₇₃₀^{ND}(1.0) is 20 cm⁻¹ or less. w₁₇₃₀^{ND}(1.0) is preferably 19 cm⁻¹ or less. Further, w₁₇₃₀^{ND} (1.0) is preferably 14 cm⁻¹ or more. w₁₇₃₀^{ND} (1.0) is more preferably 15 cm⁻¹ or more.

When the full width at half maximum of the Raman peak of a wavenumber in the vicinity of 1730 cm⁻¹ of the first film 31 at a position 1.0 μm in the thickness direction from the metal sheet 20 side is 20 cm⁻¹ or less in both the in-plane direction and the thickness direction, then the polyethylene terephthalate has formed isotropic crystals in the first film 31 at the position in the vicinity of the metal sheet 20. When the polyethylene terephthalate forms isotropic crystals in the vicinity of the metal sheet 20 in this way, this is effective in suppressing retort whitening.

The mechanism of retort whitening is presumed to be as follows. Water vapor that passes through the first film 31 in the early stage of the retort sterilization treatment condenses in the vicinity of the interface between the metal sheet 20 and the first film 31 as the water vapor is cooled by low-temperature retort content, and as the water vapor evaporates as the temperature of the retort content rises, air bubbles are formed that appear white. Therefore, when the temperature of the retort content rises, when the crystallinity of the first film 31 in the vicinity of the metal sheet 20 is high, that is, when the expressions (1) and (2) are satisfied, retort whitening can be suppressed.

When the first film 31 is a biaxially stretched polyethylene terephthalate film, the C═O bonds of the ester groups of the oriented and crystallized polyethylene terephthalate are oriented in the in-plane direction of the film. That is, the C═O bonds oriented in the out-of-plane direction of the film originate from amorphous polyethylene terephthalate that is not oriented and crystallized. Therefore, expression (2) is not satisfied. Further, in the method of producing the laminated metal sheet according to the present disclosure, described later, even when a biaxially oriented polyethylene terephthalate film is laminated at a preheating temperature lower than the range of the present disclosure, amorphization of the polyethylene terephthalate does not proceed, and expression (2) is not satisfied.

It is preferable that w(x) obtained by the linearly polarized laser Raman spectroscopic analysis for a cross section of the first film 31 satisfies the following expressions (3) and (4):

$$14 {cm}^{- 1} \leq {{w}_{1730}}^{ID} ( 3. ) \leq 20 {cm}^{- 1} \qquad ( 3 )$$

$$14 {cm}^{- 1} \leq {{w}_{1730}}^{ND} ( 3. ) \leq 20 {cm}^{- 1} \qquad ( 4 )$$

w₁₇₃₀^{ID}(3.0) is preferably 20 cm⁻¹ or less. w₁₇₃₀^{ID}(3.0) is more preferably 19 cm⁻¹ or less. Further, w₁₇₃₀^{ID}(3.0) is preferably 14 cm⁻¹ or more. w₁₇₃₀^{ND}(3.0) is more preferably 15 cm⁻¹ or more. w₁₇₃₀^{ND}(3.0) is preferably 20 cm⁻¹ or less. w₁₇₃₀^{ND}(3.0) is more preferably 19 cm⁻¹ or less. Further, w₁₇₃₀^{ND}(3.0) is preferably 14 cm⁻¹ or more. w₁₇₃₀^{ND}(3.0) is more preferably 16 cm⁻¹ or more.

When the full width at half maximum of the Raman peak of a wavenumber in the vicinity of 1730 cm⁻¹ of the first film 31 at a position 3.0 μm in the thickness direction from the metal sheet 20 side is 20 cm⁻¹ or less in both the in-plane direction and the thickness direction, the film is sufficiently crystallized and retort whitening can be effectively suppressed. Further, when the full width at half maximum of the Raman peak of a wavenumber in the vicinity of 1730 cm⁻¹ of the first film 31 at a position 3.0 μm in the thickness direction from the metal sheet 20 side is 14 cm⁻¹ or more in both the in-plane direction and the thickness direction, this indicates that the polyethylene terephthalate has been amorphized once during lamination. In such a case, the first film 31 and the metal sheet 20 are sufficiently adhered to each other, and peeling of the first film 31 from the metal sheet 20 during the retort sterilization treatment can be suppressed.

It is preferable that w(x) obtained by the linearly polarized laser Raman spectroscopic analysis for a cross section of the first film 31 satisfies the following expressions (5) and (6):

$${{w}_{1730}}^{ID} ( 5. ) \leq 16 {cm}^{- 1} \qquad ( 5 )$$

$$20 {cm}^{- 1} \leq {{w}_{1730}}^{ND} ( 5. ) \qquad ( 6 )$$

w₁₇₃₀^{ID}(5.0) is preferably 16 cm⁻¹ or less. w₁₇₃₀^{ID}(5.0) is more preferably 15 cm⁻¹ or less. Further, w₁₇₃₀^{ID}(5.0) is more preferably 13 cm⁻¹ or more. w₁₇₃₀^{ID}(5.0) is preferably 20 cm⁻¹ or more. w₁₇₃₀^{ND}(5.0) is more preferably 22 cm⁻¹ or more. Further, w₁₇₃₀^{ND} (5.0) is more preferably 26 cm⁻¹ or less.

When the full width at half maximum of the Raman peak of a wavenumber in the vicinity of 1730 cm⁻¹ of the first film 31 at a position 5.0 μm in the thickness direction from the metal sheet 20 side is 16 cm⁻¹ or less in the in-plane direction and 20 cm⁻¹ or more in the thickness direction, then the benzene rings are oriented and crystallized so as to be oriented approximately in-plane. That is, the oriented crystals of the original stretched polyethylene terephthalate film before lamination remain. In this way, when oriented crystals of the original film remain at a position of 5.0 μm in the thickness direction, no excess amorphization beyond that required to ensure adhesion during lamination occurs, and the preheating temperature of the metal sheet can be decreased, which is economical.

### (Method of Producing First Film)

The first film 31 may be produced using various known methods. When producing the laminated metal sheet 10 by laminating the first film 31 onto the metal sheet 20, an extrusion coating method may be used in which a molten body of the first film extruded from a T-die of an extruder is directly thermocompressed onto the metal sheet 20. Alternatively, the first film 31 may be produced in a film production line installed separately from the laminated metal sheet production line, and then the first film 31 and the metal sheet 20 may be laminated on the laminated metal sheet production line.

A method of producing the first film 31 on a film production line is described below. However, the present disclosure is not limited to the following description.

An example of a production line for the first film 31 is a production line including a non-stretched film production process in which an extruder is used to obtain a non-stretched film from a resin composition, a stretched film production process in which the non-stretched film is stretched, and a winding process in which the film is wound into a roll.

In the non-stretched film production process, a raw material resin of homopolyethylene terephthalate or copolymerized polyethylene terephthalate and, as required, additives such as an antioxidant, an inorganic lubricant, an organic lubricant, a crystal nucleating agent, a heat stabilizer, an antistatic agent, and a coloring pigment are used. The raw material resin is preferably in the form of pellets. From the viewpoint of ease of handling, the additive is preferably in the form of master batch pellets in which the additive is dispersed in a resin. From the viewpoint of economy, the resin in which the additives are dispersed in the master batch pellets is preferably homopolyethylene terephthalate. The raw material resin and pellets of additive can be mixed by dry blending to form a resin mixture. The resin mixture is optionally dried with hot air or under vacuum before being fed to an extruder.

The raw material resin fed to the extruder is heated to its melting point or higher and melted. The additives and the molten raw resin are kneaded in the extruder to form a resin composition in which the additives are dispersed in polyethylene terephthalate. The resin composition is extruded through a T-die after foreign matter, modified resin, and the like are removed using a filter, and then formed into a molten resin sheet. In order to improve the metering performance of the extrusion, it is preferable to provide the extruder with a feeder or a gear pump. In order to omit a process of drying the resin mixture and to suppress hydrolysis during extrusion, it is preferable to install a vacuum pipe for decreasing pressure inside the extruder.

When the first film 31 is formed of a plurality of layers, for example, one sheet of the first film 31 may be formed by laminating the plurality of layers using a co-extrusion method. In such a case, a feed block or a multi-manifold die may be used to melt-extrude the resin composition or the like that is to be the material for forming each layer using a plurality of extruders.

The molten resin sheet discharged from the T-die is cooled and solidified by a cooling device such as a cast roll, and becomes a non-stretched film. When the molten resin sheet is cooled and solidified, it is preferable to use electrostatic pinning, a vacuum chamber, or the like. By using such apparatus, it is possible to improve the adhesion between the cast roll or the like and the molten resin sheet, and to obtain a homogeneous non-stretched film.

In the stretched film preparation process, the non-stretched film is stretched in a film transport direction and/or a film width direction. Stretching in the film transport direction is called longitudinal stretching, and stretching in the film width direction is called transverse stretching. In the stretched film production process, either longitudinal stretching or transverse stretching may be carried out, or sequential biaxial stretching in which longitudinal stretching 35 and transverse stretching are carried out successively, or simultaneous biaxial stretching in which longitudinal stretching and transverse stretching are carried out simultaneously may be carried out. The stretched film production process may be omitted.

The longitudinal stretching is carried out, for example, by a longitudinal stretching machine equipped with a preheating roller and a stretching roller. The film before stretching is heated to a defined temperature when passing a preheating roller while being transported in the longitudinal direction. The non-stretched film that has been heated to a defined temperature by the preheating roller, is stretched in the longitudinal direction by the stretching roller rotating at a faster line speed than an immediately preceding roller. For heating the film, aside from the preheating roller, an infrared heater may be used. The infrared heater is preferably installed between the stretching roller and the roller immediately preceding the stretching roller. By installing the infrared heater at such a position, it is possible to suppress adhesion of the film to the preheating roller and to decrease the torque during stretching.

The transverse stretching is carried out, for example, by holding the width direction ends of the film with clips and widening the clip interval in the width direction of the film in a heating furnace. The heating furnace is preferably divided into several temperature zones from the entry side to the delivery side.

The sequential biaxial stretching may be carried out by successively carrying out the longitudinal stretching and the transverse stretching. The order of the longitudinal stretching and the transverse stretching may be appropriately determined. For example, the longitudinal stretching and the transverse stretching may be carried out once each, and then the longitudinal stretching may be carried out again.

The simultaneous biaxial stretching may be carried out, for example, by widening the clip interval in the film width direction and at the same time widening the clip interval in the film longitudinal direction in the transverse stretching.

In any of the longitudinal stretching, the transverse stretching, the sequential biaxial stretching, and the simultaneous biaxial stretching, the maximum temperature of the film is preferably the glass transition temperature of the non-stretched film or higher. Further, the ratio of the length of the film in the stretching direction before and after stretching is called the stretching ratio, and the stretching ratio is preferably 2.0 or more. The stretching ratio is preferably 9.0 or less.

In the stretched film production process, a heat setting treatment may be carried out. The heat setting treatment may be carried out, for example, by raising the temperature of the film after the sequential biaxial stretching to a temperature higher than the maximum temperature of the film during stretching, and, as required, by releasing tension on the film to relax the film. The heat setting treatment can increase the heat resistance of the film and suppress dimensional changes of the film over time.

In the winding process, the non-stretched film or the stretched film is wound into a roll to obtain a film roll.

Before winding into a roll, it is preferable to apply quality inspection apparatus such as a thickness gauge or a defect detector to inspect the quality of the film. The quality inspection apparatus may be installed in the non-stretched film production process or the stretched film production process, but it is more effective to install the quality inspection apparatus in the winding process, which is the final process in the film production line.

Further, it is preferable to use a trimmer to remove width direction edges of the film before winding the film into a roll. The use of a trimmer has the effect of making the width of the film uniform, contributing to stable production of a laminated metal sheet, and suppressing folding defects at the ends of the film in the width direction.

In the trimmer, it is preferable to apply oscillation rolling in which the film is passed along while being oscillated in the width direction. Oscillation rolling can prevent gauge band defects that are caused by thickness unevenness accumulating across the width of the film and resulting in unevenness across the width of the film roll.

### (Second Film)

The resin of the second film 32 is preferably homopolyethylene terephthalate or copolymer polyethylene terephthalate. When the resin of the second film 32 is homopolyethylene terephthalate or copolymer polyethylene terephthalate, the melting point of the second film 32 becomes close to the melting point of the first film 31. Therefore, when the first film 31 and the second film 32 are simultaneously thermocompression bonded to a metal sheet, both the first film 31 and the second film 32 tend to exhibit good adhesion.

As a copolymerization component of the copolymerized polyethylene terephthalate, the same components as those of the first film 31 may be suitably used. The copolymerization component of the copolymerized polyethylene terephthalate may be one of the above-mentioned components or a combination of two or more.

The copolymerization component is preferably isophthalic acid. When isophthalic acid is used as a copolymerization component of the second polyester, the content is preferably 1 mol % or more. The content is preferably 20 mol % or less. The content is more preferably 3 mol % or more. The content is more preferably 18 mol % or less. The content is even more preferably 4 mol % or more. The content is even more preferably 15 mol % or less. When isophthalic acid is used as a copolymerization component and the content is 1 mol % or more, the second film 32 and the metal sheet 20 tend to adhere to each other sufficiently. Further, when the content of isophthalic acid as a copolymerization component is 20 mol % or less, the strength of the film is high and the ease of handling is improved.

The intrinsic viscosity of the second film 32 is preferably 0.60 dL/g or more. The intrinsic viscosity is preferably 1.00 dL/g or less. The intrinsic viscosity is more preferably 0.65 dL/g or more. The intrinsic viscosity is more preferably 0.90 dL/g or less. When the intrinsic viscosity of the second film 32 is 0.60 dL/g or more, the formability of the laminated metal sheet 10 is improved. When the intrinsic viscosity of the second film 32 is 1.00 dL/g or less, energy consumption in the polymerization process and the extrusion process can be suppressed.

The second film 32 may contain the same additives as the first film 31. The second film 32 may also be configured as a plurality of layers in the thickness direction. When the second film 32 is configured as a plurality of layers, it is preferable that the content of the additive be changed for each layer. When the content of the additive is changed for each layer, it is possible to design the layer and the content for which the additive is most effective, which is economical.

The average thickness of the second film 32 is preferably 7 μm or more. The average thickness is preferably 50 μm or less. The average thickness of the second film 32 is more preferably 8 μm or more. The average thickness is more preferably 30 μm or less. The average thickness is even more preferably 10 μm or more. The average thickness is even more preferably 22 μm or less. When the average thickness of the second film 32 is 7 μm or more, better corrosion resistance can be secured when the laminated metal sheet 10 is formed into the laminated metallic container 100. When the average thickness of the second film 32 is 50 μm or less, the energy consumption required for heating during the production of the second film 32 and the laminated metal sheet 10 can be suppressed.

A sample standard deviation of the thickness of the second film 32 is preferably 10% or less of an average thickness of the second film 32. The sample standard deviation is more preferably 5% or less. When the sample standard deviation of the thickness of the second film 32 is 10% or less of the average thickness of the second film 32, breakage of the second film 32 or the metal sheet 20 can be suppressed when the laminated metal sheet 10 is formed into the laminated metallic container 100. The average and the sample standard deviation of the thickness of the second film 32 are calculated in the same manner as the average and the sample standard deviation of the thickness of the first film 31.

### (Method of Producing Second Film)

The second film 32 may be produced by using various known methods, similar to the first film 31 described above.

### (Method of Producing Laminated Metal Sheet)

A method of producing the laminated metal sheet 10 is described below. The method of producing the laminated metal sheet 10 according to the present disclosure includes a thermocompression bonding process and a rapid cooling process.

In the thermocompression bonding process, the metal sheet 20 that has been preheated and the first film 31 are thermocompression bonded together using a laminate roller to produce a thermocompression bonded body. In the thermocompression bonding process, the first film 31 is thermocompression bonded to at least one of the front surface 21 or the back surface 22 of the metal sheet 20. The metal sheet 20 is cast and rolled to a defined thickness and width, and then, as required, subjected to surface treatment such as annealing, temper rolling, and coating or plating.

The thermocompression bonding process is carried out by disposing the first film 31 between the metal sheet 20 preheated to a defined temperature and a laminate roller, and pressing the first film 31 against the metal sheet 20 by the laminate roller. At this time, the first film 31 is melted by the heat of the metal sheet 20 and is pressure-bonded to the metal sheet 20.

Hereinafter, a surface temperature of the metal sheet 20 0.5 s before the metal sheet 20 and the first film 31 come into contact with each other is referred to as the preheating temperature of the metal sheet 20. The preheating temperature of the metal sheet 20 is preferably 250° C. or higher. The preheating temperature is more preferably 260° C. or higher. The preheating temperature is more preferably 285° C. or lower. When the preheating temperature of the metal sheet 20 is 250° C. or higher, the amorphization of the first film 31 progresses in a region of the first film 31 that is 3.0 μm or less in the thickness direction from the metal sheet 20 side, and the metal sheet 20 and the first film 31 are adhered to each other with sufficient strength. When the preheating temperature of the metal sheet 20 is 285° C. or lower, it is possible to prevent the first film 31 from completely melting while in contact with the laminate roller and adhering to the laminate roller.

Further, in the thermocompression bonding process, the first film 31, the metal sheet 20 that has been preheated, and the second film 32 may be thermocompression bonded in this order to produce a thermocompression bonded body. In such a case, in the thermocompression bonding process, the first film 31 is thermocompression bonded to one of the front surface 21 or the back surface 22 of the metal sheet 20, and the second film 32 is thermocompression bonded to the other surface.

When the first film 31 and the second film 32 are thermocompression bonded to the metal sheet 20, the first film 31 and the second film 32 may be thermocompression bonded to the metal sheet 20 successively, but it is preferable to thermocompression bond both to the metal sheet 20 at the same time. When the first film 31 and the second film 32 are simultaneously thermocompression bonded to the metal sheet 20, the energy consumption required to increase the temperature of the metal sheet 20 can be suppressed, and the apparatus configuration can be simplified.

The first film 31 and the second film 32 used in the thermocompression bonding process may be preheated. In such a case, the heating temperature is preferably 180° C. or lower. By heating the first film 31 and/or the second film 32 in such a temperature range, the first film 31 and/or the second film 32 can be transported smoothly, and the preheating temperature of the metal sheet 20 can also be lowered.

The pressure applied by the laminate roller is preferably 0.35 MPa or more. The pressure applied by the laminate roller is preferably 1.50 MPa or less. The pressure applied by the laminate roller is more preferably 0.40 MPa or more. The pressure is more preferably 1.40 MPa or less. When the pressure applied by the laminate roller is 0.35 MPa or more, the entrapment of air bubbles at the interface between the metal sheet 20 and the first film 31 or the second film 32 can be suppressed, and the adhesion between the metal sheet 20 and the first film 31 or the second film 32 can be improved. When the pressure applied by the laminate roller is 1.50 MPa or less, the amount of heat transferred from the metal sheet 20 to the laminate roller through the first film 31 or the second film 32 can be suppressed, and energy consumption can be suppressed. In addition, wear on the laminate roller can be suppressed.

The laminate roller is preferably heated to a temperature in a range of −20° C. to +60° C. relative to the glass transition temperature of the first film 31. By heating the laminate roller, spontaneous temperature increase due to heat input from metal sheet 20 can be mitigated, and variation in the properties of the first film 31 in the longitudinal direction can be suppressed. The glass transition temperature of the first film 31 is determined by differential scanning calorimetry, in which the temperature of the first film 31 is increased from −50° C. to 290° C. at a rate of 10° C./min. When the baseline shifts, the glass transition temperature is determined as the average temperature of two intersection points (glass transition onset temperature, glass transition end temperature) between the tangents to the baseline before and after the shift and the inflection point during the shift.

Further, the laminate roller in contact with the second film 32 is preferably heated to a temperature in a range of −20° C. to +60° C. relative to the glass transition temperature of the second film 32. By heating the laminate roller in contact with the second film 32 in this manner, spontaneous temperature increase due to heat input from the metal sheet 20 can be mitigated, and variation in the properties of the second film 32 in the longitudinal direction can be suppressed. The glass transition temperature of the second film 32 can be determined in the same manner as the glass transition temperature of the first film 31.

In the rapid cooling process, the thermocompression bonded body produced in the thermocompression bonding process is rapidly cooled. Examples of methods of rapid cooling include a method of spraying a coolant onto the thermocompression-bonded body, and a method of immersing the thermocompression-bonded body in a coolant.

An elapsed time from the end of the thermocompression bonding process to the start of the rapid cooling process, that is, the time elapsed from when the surface of the thermocompression bonded body facing the first film 31 is separated from the laminate roller to when the surface of the thermocompression bonded body comes into contact with a coolant or the like, is defined as tq. Further, a surface temperature of the thermocompression-bonded body on the first film 31 side 0.2 s after the end of the thermocompression bonding process is defined as a temperature immediately after thermocompression bonding Tq. The temperature immediately after thermocompression bonding Tq can be measured by applying a radiation thermometer to the surface on the first film 31 side. The elapsed time tq until the start of the rapid cooling process and the temperature immediately after thermocompression bonding Tq satisfy the following expression (7).

$$0.38 \times Tq - t q - 72 \leq 0. \qquad ( 7 )$$

In the thermocompression bonding process, amorphization progresses in the first film 31, particularly on the metal sheet 20 side. However, when the elapsed time tq from the end of the thermocompression bonding process to the start of the rapid cooling process is long, the once amorphized polyethylene terephthalate will crystallize again. When the polyethylene terephthalate on the metal sheet 20 side of the first film 31 crystallizes again, the function of suppressing retort whitening is exerted. The higher the temperature immediately after thermocompression bonding Tq, the more polyethylene terephthalate is amorphized in the thermocompression bonding process, and therefore the longer the elapsed time tq until rapid cooling required to suppress retort whitening.

In order to control the elapsed time tq until the start of the rapid cooling process, the distance from the laminate roller to the coolant, the laminate roller diameter, the pressure applied by the laminate roller, the line speed, and the like may be controlled. In order to control the temperature immediately after thermocompression bonding Tq, it suffices to control the elapsed time tq until the start of the rapid cooling process, the preheating temperature and sheet thickness of the metal sheet, the film thicknesses of the first film and the second film, the diameter of the laminate roller, the material of the laminate roller and the pressure applied by the laminate roller, the temperature of the laminate roller, and the like.

Further, the surface temperature of the first film 31 side of the thermocompression bonded body immediately before rapid cooling is preferably 160° C. or higher. The surface temperature is preferably 205° C. or lower. The surface temperature is more preferably 170° C. or higher. The surface temperature is more preferably 195° C. or lower. The surface temperature is even more preferably 180° C. or higher. The surface temperature is even more preferably 190° C. or lower. The surface temperature of the first film 31 side of the thermocompression bonded body immediately before rapid cooling is represented by a temperature measurement taken 0.2 s before the start of the rapid cooling process.

When the surface temperature of the first film 31 side of the thermocompression bonded body immediately before rapid cooling is 205° C. or lower, this is a temperature range in which crystallization is likely to occur, and the elapsed time tq until the start of the rapid cooling process can be minimized, thereby making it possible to decrease the scale of the apparatus. When the surface temperature of the first film 31 side of the thermocompression bonded body immediately before rapid cooling is 160° C. or higher, the first film 31 and the metal sheet 20 will be sufficiently adhered to each other, and the elapsed time tq until the start of the rapid cooling process will not be excessively long, which is economical.

The elapsed time tq from the end of the thermocompression bonding process to the start of the rapid cooling process is preferably 1.0 s or longer. The elapsed time tq is preferably 10 s or shorter. The elapsed time tq is more preferably 2.0 s or longer. The elapsed time tq is more preferably 8.0 s or shorter. The elapsed time tq is even more preferably 2.5 s or longer. The elapsed time tq is even more preferably 5.0 s or shorter. When the elapsed time tq until the start of the rapid cooling process is 1.0 s or longer, the temperature immediately after thermocompression bonding Tq can be made 193° C. or higher, and the first film 31 can be sufficiently amorphized in the thermocompression bonding process, and the first film 31 and the metal sheet 20 can be sufficiently adhered to each other. When the elapsed time tq until the start of the rapid cooling process is 10 s or shorter, when laminating at a line speed of 60 m/min for example, a distance between the end of the thermocompression bonding process and the start of the rapid cooling process can be set to 10 m or less, making it possible to decrease the scale of the apparatus.

The coolant used in the rapid cooling process may be water, oil such as silicone oil, or an organic solvent, but is preferably water, and more preferably deionized water or distilled water. When deionized water or distilled water is used as the coolant, the amount of impurity such as minerals is small, and therefore the precipitation of impurities can be suppressed even when drying is carried out after the rapid cooling process. When industrial water or tap water is used as the coolant, it is preferable to rinse the product with deionized water or distilled water after rapid cooling in order to prevent appearance defects caused by precipitation of impurities.

The coolant used in the rapid cooling process may be heated for operational stability. The temperature of the coolant is preferably 10° C. or higher. Further, the temperature of the coolant is preferably +40° C. or less, relative to the glass transition temperature of the first film 31. When the temperature of the coolant is 10° C. or higher, freezing in the coolant tank and stains due to condensation on the coolant piping can be effectively prevented. When the temperature of the coolant is +40° C. or less, relative to the glass transition temperature of the first film 31, the first film 31 can be smoothly transported without sticking to the pass line rollers arranged after the rapid cooling process.

After the rapid cooling process, the thermocompression bonded body is preferably subjected to removal of the coolant by a squeeze roller. The thermocompression bonded body is subjected to a post-heat treatment and an oil coating treatment as required. The thermocompression bonded body is inspected for surface defects, internal defects, sheet thickness, and the like, as required, and then coiled into a coil by, for example, a tension reel, to become the laminated metal sheet 10. The thermocompression bonded body may be slit or sheared to form the laminated metal sheet 10 as a sheet.

### (Method of Producing Laminated Metallic Container)

The laminated metallic container 100 is formed by using the laminated metal sheet 10 for at least one of the members constituting the laminated metallic container 100. As described above, the laminated metallic container 100 may be, for example, a three-piece can made up of three members, or a two-piece can made up of two members. The laminated metallic container 100 is formed by a known method. The laminated metallic container 100 can be efficiently formed, for example, by using a canning machine.

The laminated metallic container 100 may be coated, printed, or wrapped with paper. The laminated metallic container 100 is particularly suitable for use as a container that is subjected to a retort sterilization treatment.

According to the above embodiment, an example has been described in which the laminated metal sheet 10 has the metal sheet 20 having the front surface 21 which is the outer surface of the laminated metallic container 100 and the back surface 22 which is the inner surface. The laminated metal sheet 10 can be provided freely according to the embodiment. For example, the front surface 21 of the metal sheet 20 may be the inner surface of the laminated metallic container 100, and the back surface 22 may be the outer surface of the laminated metallic container 100. In such a case, the first film 31 may be provided only on the surface 21 which will be the inner surface of the laminated metallic container 100.

As described above, the laminated metal sheet 10 and the laminated metallic container 100 according to the present disclosure have basic properties such as formability, adhesion between the film and the metal sheet, and corrosion resistance, and can prevent degradation of appearance due to whitening even when subjected to retort sterilization treatment. According to the production method of the present disclosure, it is possible to produce the laminated metal sheet 10 that suppresses retort whitening by utilizing existing lamination equipment, without the need to use expensive polybutylene terephthalate or to carry out further post-heating treatment after lamination.

### EXAMPLES

Description in more detail is provided below by way of examples, but the present disclosure not necessarily limited to the examples described.

The method of producing the laminated metal sheets used for the Examples and Comparative Examples and the methods for measuring property values are as follows.

### (Preparation of Laminated Metal Sheet)

As the metal sheet 20, TFS was used. As the steel substrate for the TFS, low carbon steel having a temper designation of T3CA and a sheet thickness of 0.22 mm that had been subjected to cold rolling, annealing, and temper rolling was used. The TFS was prepared by degreasing, pickling, and then chromium plating the low carbon steel. The coating weight of chromium plating on the TFS was, in Cr equivalent, 120 mg/m² of metallic chromium and 10 mg/m² of hydrated chromium oxide.

As the first film 31 laminated on the front surface 21 of the metal sheet 20 and the second film 32 laminated on the back surface 22 of the metal sheet 20, biaxially stretched polyethylene terephthalate film was used.

Next, the TFS, the first film 31, and the second film 32 were laminated by a thermocompression lamination method. Specifically, a pair of laminate rollers were arranged to sandwich the metal sheet 20, the first film 31 was arranged between the front surface 21 of the metal sheet 20 and the laminate roller on the surface side, and the second film 32 was arranged between the back surface 22 of the metal sheet 20 and the laminate roller on the back surface side. The metal sheet 20 that had been preheated was passed between the laminate rollers to carry out thermocompression bonding.

The TFS was passed through the laminate rollers, and after a certain time had passed since the first film 31 separated from the laminate roller on the front side, the TFS was immersed in tap water to rapidly cool, thereby obtaining the laminated metal sheet 10 for which the first film 31 and the second film 32 were laminated on both sides of the TFS.

Table 1 lists the resin compositions of the first film 31 and the second film 32, the conditions for thermocompression bonding, and the conditions for rapid cooling.

TABLE 1

| | First film | | | | | | |
|---|---|---|---|---|---|---|---|
| | | | | Glass | Cooling | Second film | |
| | Resin | | | transition | crystallization | Resin | |
| | composition | | Intrinsic | temperature | peak temperature | composition | |
| | PET | IA | viscosity | Tg | Tcc | PET | IA |
| | (mol %) | (mol %) | (dL/g) | (° C.) | (° C.) | (mol %) | (mol %) |
| Example 1 | 100 | 0 | 0.65 | 80 | 191 | 100 | 0 |
| Example 2 | 95 | 5 | 0.64 | 79 | 187 | 90 | 10 |
| Example 3 | 100 | 0 | 0.65 | 80 | 191 | 90 | 10 |
| Example 4 | 100 | 0 | 0.67 | 79 | 206 | 100 | 0 |
| Example 5 | 100 | 0 | 0.65 | 80 | 191 | 100 | 0 |
| Comparative Example 1 | 84 | 16 | 0.66 | 78 | 184 | 100 | 0 |
| Comparative Example 2 | 100 | 0 | 0.65 | 80 | 191 | 100 | 0 |

| | Second film | | Thermocompression bonding | | Rapid cooling | |
|---|---|---|---|---|---|---|
| | | Glass | | Temperature | Elapsed | |
| | | transition | Metal sheet | immediately after | time to | 0.38 × |
| | Intrinsic | temperature | preheating | thermocompression | rapid | Tq − |
| | viscosity | Tg | temperature | bonding Tq | cooling tq | tq − |
| | (dL/g) | (° C.) | (° C.) | (° C.) | (s) | 72 |
| Example 1 | 0.65 | 80 | 260 | 200 | 5 | −1.0 |
| Example 2 | 0.64 | 78 | 260 | 195 | 4 | −1.9 |
| Example 3 | 0.64 | 78 | 290 | 230 | 16 | −0.6 |
| Example 4 | 0.65 | 80 | 260 | 200 | 5 | −1.0 |
| Example 5 | 0.65 | 80 | 245 | 200 | 5 | −1.0 |
| Comparative Example 1 | 0.65 | 80 | 260 | 215 | 5 | 4.7 |
| Comparative Example 2 | 0.65 | 80 | 245 | 193 | 1 | 0.3 |

### (Linearly Polarized Laser Raman Spectroscopy)

A microscope laser Raman spectroscopy measuring device LabRAM HR Evolution, produced by Horiba, Ltd., was used to carry out linearly polarized laser Raman spectroscopic analysis on a machine direction (MD) cross section of the laminated metal sheet.

The prepared laminated metal sheet was embedded in resin and polished to prepare the MD cross section, which was then used as a sample for observation.

The laser wavelength was 532 nm, the aperture diameter was 25 μm, and the exposure time was 5 s, with two exposures. The diffraction grating was 300 gr/mm, the focal length was 800 mm, and the objective lens was set to 100 times magnification.

The full width at half maximum of the C═O stretching vibration peak in the vicinity of 1730 cm⁻¹ when linearly polarized laser light polarized in the machine direction was incident at a position x μm in the thickness direction from the metal sheet side was taken as w₁₇₃₀^{ID}(x). Further, the full width at half maximum of the C═O stretching vibration peak in the vicinity of 1730 cm⁻¹ when linearly polarized laser light polarized in the Z direction was incident was taken as w₁₇₃₀^{ND}(x). The following expressions (1) to (6) were checked.

$${{w}_{1730}}^{ID} ( 1. ) \leq 20 {cm}^{- 1} \qquad ( 1 )$$

$${{w}_{1730}}^{ND} ( 1. ) \leq 20 {cm}^{- 1} \qquad ( 2 )$$

$$14 {cm}^{- 1} \leq {{w}_{1730}}^{ID} ( 3. ) \leq 20 {cm}^{- 1} \qquad ( 3 )$$

$$14 {cm}^{- 1} \leq {{w}_{1730}}^{ND} ( 3. ) \leq 20 {cm}^{- 1} \qquad ( 4 )$$

$${{w}_{1730}}^{ID} ( 5. ) \leq 16 {cm}^{- 1} \qquad ( 5 )$$

$$20 {cm}^{- 1} \leq {{w}_{1730}}^{ND} ( 5. ) \qquad ( 6 )$$

### (Evaluation of Adhesion)

A sample measuring 100 mm in the transport direction and 30 mm in the sheet transverse direction was cut out from the laminated metal sheet. A portion of the film was peeled off from the long side edge of the cut sample. The peeled off film was opened in the opposite direction to the direction of peeling (angle: 180°), a 100 g weight was fixed thereto, and retort sterilization treatment was carried out under pressurized steam at 125° C. for 25 min. The peel length of the film after the retort sterilization treatment was measured and evaluated according to the following criteria.
A: less than 2 mm
B: 2 mm or more and less than 10 mm
C: 10 mm or more

### (Evaluation of Retort Whitening)

A sample having a diameter of 48 mm was punched out from the laminated metal sheet. The sample was attached to the bottom of a commercially available 350 mL negative pressure steel can (diameter 66 mm, height 122.2 mm) using a doughnut-shaped magnet with an outer diameter of 50 mm and an inner diameter of 30 mm. The steel cans to which the samples were attached were subjected to retort sterilization treatment in pressurized steam at 130° C. for 10 min. After the retort sterilization treatment, the sample was removed from the steel can, and the change in appearance was visually observed and evaluated according to the following criteria.
A: no change in appearance
B: slight whitening in appearance (area fraction less than 5%)
C: appearance was cloudy (area fraction 5% or more)

### (Evaluation of Formability)

Paraffin wax was applied to the laminated metal sheet, and then a sample having a diameter of 200 mm was punched out. The sample was deep-drawn into a cup with a draw ratio of 2.00 using a cupping press so that the first film was on a can outer surface side. Next, the obtained cup was subjected to a two-stage redrawing process so that drawing ratios were 2.20 and 2.50, and panel working was carried out on the can bottom. The worked portion of the bottom panel of the obtained can body was observed and evaluated according to the following criteria.
A: no damage to the film after forming.
B: partial damage was observed in the film after forming. No problem for utility.
C: slight damage was observed all around the periphery of the film after forming. Problem for utility.

### (Evaluation Results)

The evaluation results for the obtained laminated metal sheets of Examples 1 to 5 and Comparative Examples 1 and 2 are listed in Table 2.

For Comparative Examples 1 and 2, degradation in appearance occurred after retort sterilization. Further, for Comparative Example 2, good results were not obtained in the evaluation of the adhesion and the formability of the laminated metal sheet. For Examples 1 to 4, good results were obtained in the evaluation of the appearance, the adhesion, the retort whitening, and the formability of the laminated metal sheets. For Example 3, good results were obtained in the evaluation of the adhesion, the retort whitening resistance, and the formability, but the appearance of the laminated metal sheet was somewhat poor. For Example 5, good results were obtained in the evaluation of the appearance, the retort whitening resistance, and the formability of the laminated metal sheet, but the adhesion was somewhat poor.

Accordingly, it has been confirmed that the present disclosure can provide an inexpensive, low-environmental-burden laminated metal sheet and laminated metallic container that have basic properties such as formability, adhesion between the film and the metal sheet, and corrosion resistance, and that do not suffer from degradation in appearance due to whitening even when subjected to retort sterilization treatment.

TABLE 2

| | Raman spectroscopy | | | | | | Laminated | | | |
|---|---|---|---|---|---|---|---|---|---|---|
| | First film | | | | | | metal sheet | | Retort | Form- |
| | w₁₇₃₀^{ID}(1.0) | w₁₇₃₀^{ND}(1.0) | w₁₇₃₀^{ID}(3.0) | w₁₇₃₀^{ND}(3.0) | w₁₇₃₀^{ID}(5.0) | w₁₇₃₀^{ND}(5.0) | appearance | Adhesion | whitening | ability |
| Example 1 | 18 | 18 | 17 | 19 | 14 | 23 | A | A | A | A |
| Example 2 | 19 | 19 | 18 | 19 | 14 | 23 | A | A | A | A |
| Example 3 | 19 | 19 | 18 | 19 | 18 | 19 | B | A | A | A |
| Example 4 | 16 | 18 | 16 | 18 | 14 | 22 | A | A | A | A |
| Example 5 | 18 | 19 | 13 | 17 | 14 | 23 | A | B | A | B |
| Comparative | 24 | 24 | 17 | 24 | 14 | 23 | B | A | C | A |
| Example 1 | | | | | | | | | | |
| Comparative | 15 | 24 | 14 | 23 | 14 | 23 | A | C | C | C |
| Example 2 | | | | | | | | | | |

### INDUSTRIAL APPLICABILITY

According to the present disclosure, it is possible to provide an inexpensive laminated metal sheet and laminated metallic container that have basic properties such as formability, adhesion between the film and the metal sheet, and corrosion resistance, and that do not suffer from degradation in appearance due to whitening even when subjected to retort sterilization treatment.

### REFERENCE SIGNS LIST

10 laminated metal sheet
11 container body
12 lid portion
20 metal sheet
21 front surface
22 back surface
31 first film
32 second film
100 laminated metallic container

1. A laminated metal sheet comprising a first film laminated on at least one of a front surface and a back surface of a metal sheet, wherein
the first film is homopolyethylene terephthalate or copolymer polyethylene terephthalate, wherein
w(x) obtained by a linearly polarized laser Raman spectroscopic analysis for a cross section of the first film satisfies the following expressions (1) and (2):
$${{w}_{1730}}^{ID} ( 1. ) \leq 20 {cm}^{- 1} \qquad ( 1 )$$
$${{w}_{1730}}^{ND} ( 1. ) \leq 20 {cm}^{- 1} \qquad ( 2 )$$
where w₁₇₃₀^{ID}(x) is the full width at half maximum of a peak due to C═O stretching vibration in the vicinity of 1730 cm⁻¹ when linearly polarized laser light is incident on the cross section of the first film at a position x μm away from the metal sheet side in the thickness direction of the film, with the polarization plane of the light being parallel to the in-plane direction of the film, and
w₁₇₃₀^{ND}(x) is the full width at half maximum of a peak due to C═O stretching vibration in the vicinity of 1730 cm⁻¹ when linearly polarized laser light is incident on the cross section of the first film at a position x μm away from the metal sheet side in the thickness direction, with the polarization plane of the light being parallel to the thickness direction of the film.

2. The laminated metal sheet according to claim 1, wherein
w(x) obtained by the linearly polarized laser Raman spectroscopic analysis for a cross section of the first film satisfies the following expressions (3) and (4):
$$14 {cm}^{- 1} \leq {{w}_{1730}}^{ID} ( 3. ) \leq 20 {cm}^{- 1} \qquad ( 3 )$$
$$14 {cm}^{- 1} \leq {{w}_{1730}}^{ND} ( 3. ) \leq 20 {cm}^{- 1} . \qquad ( 4 )$$

3. The laminated metal sheet according to claim 1, wherein
w(x) obtained by the linearly polarized laser Raman spectroscopic analysis for a cross section of the first film satisfies the following expressions (5) and (6):
$${{w}_{1730}}^{ID} ( 5. ) \leq 16 {cm}^{- 1} \qquad ( 5 )$$
$$20 {cm}^{- 1} \leq {{w}_{1730}}^{ND} ( 5. ) . \qquad ( 6 )$$

4. The laminated metal sheet according to claim 2, wherein
w(x) obtained by the linearly polarized laser Raman spectroscopic analysis for a cross section of the first film satisfies the following expressions (5) and (6):
$${{w}_{1730}}^{ID} ( 5. ) \leq 16 {cm}^{- 1} \qquad ( 5 )$$
$$20 {cm}^{- 1} \leq {{w}_{1730}}^{ND} ( 5. ) . \qquad ( 6 )$$

5. A method of producing a laminated metal sheet, the method comprising:
a thermocompression bonding process of thermocompressing a metal sheet that has been preheated and a first film using a laminate roller to produce a thermocompression bonded body; and
a rapid cooling process of rapidly cooling the thermocompression bonded body, wherein
the first film is homopolyethylene terephthalate or copolymer polyethylene terephthalate, and
an elapsed time tq from an end point of the thermocompression bonding process to a start point of the rapid cooling process and a surface temperature Tq of a first film side of the thermocompression bonded body 0.2 s after the end point of the thermocompression bonding process satisfy the following expression (7):
$$0.38 \times Tq - t q - 72 \leq 0. \qquad ( 7 )$$

6. The method of producing a laminated metal sheet according to claim 5, wherein
a preheating temperature of the metal sheet in the thermocompression bonding process is 250° C. or higher.

7. A laminated metallic container comprising the laminated metal sheet according to claim 1 as a material.

8. A laminated metallic container comprising the laminated metal sheet according to claim 2 as a material.

9. A laminated metallic container comprising the laminated metal sheet according to claim 3 as a material.

10. A laminated metallic container comprising the laminated metal sheet according to claim 4 as a material.
